(19) United States
(12) Patent Application Publication
(10) Pub. No.: US 2008/0025025 A1
(43) Pub. Date: Jan. 31, 2008

(54) Ornamental LED lamp string assembly

(76) Inventor: Kwo Kiun George Tong, Hong Kong (CN)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/639,008

(22) Filed: Dec. 14, 2006

(30) Foreign Application Priority Data
Jul. 28, 2006 (CN) 200620017280.8

(51) Int. Cl. F21S 13/14

(52) U.S. Cl. 362/252

(57) ABSTRACT

An ornamental LED lamp string assembly comprising lamp subassemblies, ornamental hoods, a power supply unit and conducting wires, said lamp subassembly comprises a shell, a socket sleeve and a light-emitter, the light-emitter is inserted into the socket sleeve and they are inserted, in turn, into the shell; said wires connect output terminals of the power supply unit to all the lamp subassemblies; particularly, said light-emitter are all LED devices of the same specification emitting white or light-yellow light; said hoods comprises monochromatic items at least of two kinds in similar sizes, however, the two kinds of hoods are in different colors. Owing to the fact that said light-emitters are all LED devices of the same specification, their brightness is the same, and power supply efficiency is enhanced, its service life is lengthened.

### TECHNICAL FIELD

This invention relates to ornamental lighting lamp strings consisting of semiconductor-lightening devices, and more particularly, it relates to LED lamp strings assembly with lightening devices of the same specification.

### BACKGROUND ART

The prior art for ornamental LED (light-emitting diode) lamp strings usually adopts LED devices that emit only monochromatic light, and LED devices of not fewer than two colors are connected by conducting wires with control circuits powered by batteries. LED devices of different colors have different range of starting voltage, working voltage and voltage-withstand values, e.g., LED emitting red light needs relative low working voltage while LED emitting white light requires higher working voltage, and their working currents are also different. Hence, it is necessary to connect resistors with suitable resistance values in series with the LED devices separately to enable LED lamp strings, which emit multiple-color lights, work normally. The polychromatic LED lamp strings of prior art have shortcomings as the following:

1. Energy is consumed extra in the resistors in series, resulting in low working efficiency and shortened service life of batteries;

2. Owing to different starting voltage and voltage-withstand values of LED devices, which emit different color lights, lamp string luminance adjustment by way of voltage change shall result in problems such as not all the LED devices emit light at the same time and LED devices, which have lower voltage-withstand value, are burnt;

3. LED devices emitting different color lights have different luminance once they are applied with their nominal voltage, and when they are in the same lamp string, those ones, which emit weaker luminance, would give an impression of inferior quality.

### SUMMARY OF THE CURRENT INVENTION

The technical problem that the current invention aims to solve is to avoid the shortcomings of the prior art and to provide an ornamental lamp string assembly that can emit different color lights with the same luminance, have

high working efficiency of batteries, longer service life and easiness in luminance adjustment.

The technical solution of the current invention can be realized by means of the following preferred embodiment:

Design and adopt an ornamental LED lamp string assembly comprising lamp subassemblies, ornamental hoods, a power supply unit and conducting wires. Said lamp subassembly comprises a shell, a socket sleeve and a light-emitter; and said light-emitter is inserted into the socket sleeve and they are inserted, in turn, into the shell; said conducting wires connect output terminals of the power supply unit to all the lamp subassemblies; particularly, said light-emitters are all LED devices of the same specification emitting white or light-yellow light.

Said ornamental hoods are monochromatic items in different colors and in any three-dimensional or planar shapes, including hollow globe, hollow cylinder, hollow cone or thin disc with a hole in the centre.

Said power supply unit is a battery box in which are installed galvanic cells or rechargeable battery; said power supply unit can be an adapter likewise, including industrial frequency transformer or switching power supply, viz. electronic transformer; and the said power supply unit can be also a line powered directly from utility circuit, including fuses or air breaker in series.

Said LED lamp string assembly also comprises a control switch and a sensor, the conducting wires connect said sensor to said control switch, and said LED lamp string assembly can be controlled by said control switch as a whole, or divided into, at least, two circuits powered and controlled separately.

Said sensor is light-, sound- and/or vibration-sensitive, which controls, when the control switch on said battery box is closed, lighting, putting out or flashing of said LED lamp string assembly based on the environment conditions, e.g., if a light-sensitive sensor is used, when the control switch on the battery box is closed and the environment light is strong, all the light-emitters of said lamp string assembly will not be lighted; when the environment light is dim, all these light-emitters will be lighted. If sound-sensitive sensor is used together with the light-sensitive sensor simultaneously, sound generated by clapping hands will cause these already lighted light-emitters flashing, or on the contrary.

Compared with the prior art, the current invention “ornamental LED lamp string assembly” has the advantageous effects as the following:

1. All the light-emitters in said LED lamp string assembly are LED devices of the same specification, which emit white or light-yellow light, no resistors in series will be needed in order to let all light-emitters emit same luminance, thus enhancing power supply efficiency and lengthening its service life;

2. Said LED lamp string assembly has light-emitters that are LED devices of the same specification emitting white or light-yellow light, and starting, working voltage and voltage-withstand values of all the light-emitters are the same. It is much easier to adjust luminance of the lamp string by way of changing voltage;

3. Colors of light emitted by said LED lamp string assembly depend on the colors of said ornamental hoods, hence, it is easy to change colors of light emitted by said LED lamp string assembly, e.g., if a red-green lamp string is to be changed into a yellow-blue one, the only thing to do is to replace said hoods by ones of required color;

4. Because colors of light emitted by said LED lamp string assembly depend on colors of said ornamental hoods, hence, the light of some color which is impossible to be emitted by LED of prior art, can be obtained with the aid of said ornamental hoods, e.g., no LED of prior art emits brown light, but the light emitted by LEDs of said lamp string assembly looks like brown color with the aid of brown ornamental hood.

### BRIEF DESCRIPTION OF FIGURES

FIG. 1 is a planar appearance sketch of the current invention “LED lamp string assembly”;

FIG. 2 is a three-dimensional structure sketch of said “LED lamp string assembly”, where a hollow global ornamental hood 20 is covered on and inserted into the lamp subassembly 10;

FIG. 3 is a sketch of exploded view of FIG. 2;

FIG. 4 is a three-dimensional sketch of said lamp subassembly 10 of the “LED lamp string assembly”, where the light-emitter 13 is inserted into the socket sleeve 12;

FIG. 5 is a cutaway view of said hollow global ornamental hood 20.

### DETAILED DESCRIPTION OF THE PREFERRED EMBODIMENTS

Detailed description on the current invention is given together with embodiments shown by accompanying drawings as follows:

The current invention “ornamental LED lamp string assembly” comprises lamp subassemblies 10, ornamental hoods 20, a power supply unit 30 and conducting wires 50. Said lamp subassembly 10 comprises a shell 11, a socket sleeve 12 and a light-emitter 13; said light-emitter 13 is inserted into the socket sleeve 12 and they are inserted, in turn, into the shell 11; said conducting wires 50 connect output terminals of the power supply unit 30 to all the lamp subassemblies 10; particularly, said light-emitters 13 are all LED devices of the same specification emitting white or light-yellow light.

Said ornamental hoods 20 are monochromatic items in different colors and of any three-dimensional or planar shape, including hollow globe, hollow cylinder, hollow cone or thin disc with a hole in the center.

Said LED lamp string assembly also comprises a control switch 31 and a sensor 40, the conducting wires 50 connect said sensor 40 to said control switch 31, and said LED lamp string assembly can be controlled by said control switch 31 as a whole, or divided into, at least, two circuits powered and controlled separately. Said sensor 40 is light-, sound- and/or vibration-sensitive.

In this embodiment, said power supply unit 30 is a battery box in which are installed galvanic cells or rechargeable battery. But said power supply unit 30 includes not only the battery box but also an adapter or a line powered directly from utility circuit. Said adapter includes industrial frequency transformer or switching power supply, viz. electronic transformer; said line powered directly from utility circuit includes fuses or air breaker in series.

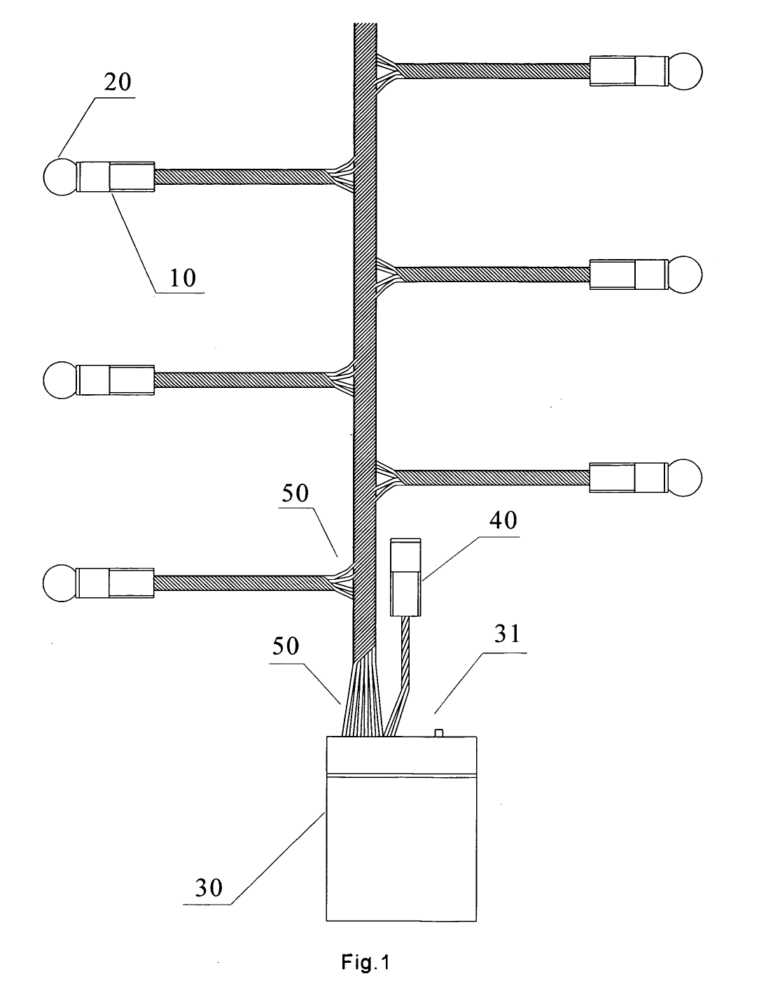

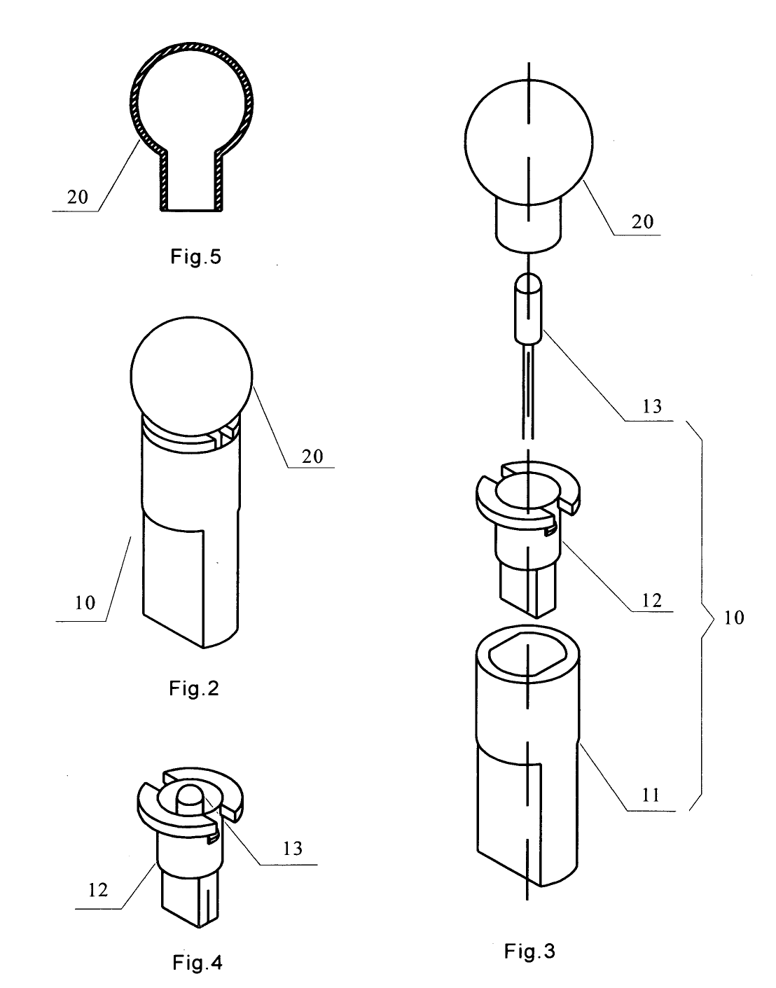

When said ornamental hood 20 is a hollow globe in shape, said LED lamp string assembly shall have an appearance as shown in the planar sketch of FIG. 1. When said ornamental hood 20 is a hollow globe in shape, its structure is shown in FIG. 5. When said hollow global ornamental hood 20 is covered on and inserted into the lamp subassembly 10, its three-dimensional structure sketch is shown in FIG. 2, and FIG. 3 is its exploded view. FIG. 4 is a three-dimensional sketch for structure of said light-emitter 13 inserted into the socket sleeve 12.

All the light-emitters 13 in said LED lamp string assembly are LED devices of the same specification emitting white or light-yellow light, which can generate the same luminance without resistors in series and all electric energy supplied by the battery is basically consumed in said light-emitters 13, thus enhancing battery efficiency and prolongating service life over the prior art.

All the light-emitters 13 in said LED lamp string assembly are LED devices of the same specification, which emit high-luminance white or light-yellow light, and their starting and working voltages and voltage-withstand values are the same, thus it is much simpler and easier to adjust luminance of the lamp string by way of changing voltage.

Color of light emitted by said LED lamp string depends on color of said ornamental hoods 20, hence it is easy to change color of light generated by said LED lamp string assembly, e.g., if a red-green lamp string is to be changed to yellow-blue, the only thing to do is to replace the said ornamental hoods 20 by ones of required color.

Because colors of light emitted by said LED lamp string assembly depend on colors of said ornamental hoods 20, hence, the light of some color which is impossible to be emitted by LED of prior art, can be obtained with the aid of said ornamental hoods, e.g., no LED of prior art emits brown light, but the light emitted by LEDs of said lamp string assembly looks like brown color with the aid of brown ornamental hood.

What is claimed is:

1. An ornamental LED lamp string assembly, comprising lamp subassemblies, ornamental hoods, a power supply unit and conducting wires; said lamp subassembly comprises a shell, a socket sleeve and a light-emitter, and said light-emitter is inserted into the socket sleeve and they are inserted, in turn, into the shell; said conducting wires connect output terminals of the power supply unit to all the lamp subassemblies, is characterized by: said light-emitters are all LED devices of the same specification emitting white or light-yellow light.

2. An ornamental LED lamp string assembly as defined in claim 1 is characterized by: said ornamental hoods are monochromatic items in different colors.

3. An ornamental LED lamp string assembly as defined in claim 1 is characterized by: said ornamental hoods are of any three-dimensional or planar shape, including hollow globe, hollow cylinder, hollow cone or thin disc with a hole in the center.

4. An ornamental LED lamp string assembly as defined in claim 1 is characterized by: said power supply unit is a battery box in which are installed galvanic cells or rechargeable battery.

5. An ornamental LED lamp string assembly as defined in claim 1 is characterized by: said power supply unit is a adapter, including industrial frequency transformer or switching power supply, viz. electronic transformer.

6. An ornamental LED lamp string assembly as defined in claim 1 is characterized by: said power supply unit is a line powered directly from utility circuit, including fuses or air breaker in series.

7. An ornamental LED lamp string assembly as defined in claim 1 is characterized by: it also comprises a control switch and a sensor, the conducting wires connect said sensor to said control switch, and said LED lamp string assembly can be controlled by said control switch as a whole, or divided into, at least, two circuits powered and controlled separately.

8. An ornamental LED lamp string assembly as defined in claim 4 is characterized by: said sensor is light-, sound- and/or vibration-sensitive.
